(19) United States
(12) Patent Application Publication
(10) Pub. No.: US 2009/0038161 A1
(43) Pub. Date: Feb. 12, 2009

(54) Device for cutting continuously moving zipper

(75) Inventors: Clifton R. Howell, Buford, GA (US); David C. Wallace, Lilburn, GA (US); Adam N. Caplan, Atlanta, GA (US)

Correspondence Address: DAY PITNEY LLP;ACCOUNT: ILLINOIS TOOL WORKS INC., 7 TIMES SQUARE, NEW YORK, NY, 10036-7311, US

(73) Assignee: ILLINOIS TOOL WORKS INC.

(21) Appl. No.: 11/891,182

(22) Filed: Aug. 9, 2007

(51) Int. Cl. B26D 1/06

(52) U.S. Cl. 30/173

(57) ABSTRACT

The apparatus provides a cutting device, particularly adapted for cutting a moving length of zipper material in the manufacture of reclosable packages. Upper and lower opposed stationary blades are provided thereby providing opposed cutting edges. A reciprocating blade, with upper and lower cutting surfaces, reciprocates within a slot immediately adjacent to the stationary blades, thereby allowing the reciprocating blade to cut on both its upward and downward reciprocating strokes.

### BACKGROUND OF THE INVENTION

1. Field of Invention

This invention pertains to a device for cutting lengths of moving zipper material in the manufacture of reclosable packages. The device includes two opposed stationary blades, wherein the zipper passes therebetween, and a double-edge reciprocating blade which cuts the zipper material on both the up and down strokes of a reciprocation cycle.

2. Description of the Prior Art

The prior art of methods of manufacture of reclosable packages is very well-developed and generally satisfactory for its intended purposes in most respects. However, as with virtually all methods of manufacture, there is always the desire to increase production speeds and reduce production costs.

Many methods of manufacture of reclosable packages use lengths of zipper material which are provided in the machine direction, and which must be cut into individual package-width lengths sometime during the manufacturing process. Sometimes, this requires intermittent motion of the zipper material. That is, the zipper length must be stopped in order to perform the cutting reliably. This intermittent stopping and starting of the zipper material is increasingly problematic at higher production speeds.

Previous designs have used a four-pointed star-shaped cutter which rotated ninety degrees during every cutting cycle. This design, however, is too large and complicated for some applications.

### OBJECTS AND SUMMARY OF THE INVENTION

It is therefore an object of the present invention to provide a cutter for lengths of zipper material in the manufacturing process of a reclosable package, wherein increased manufacturing speeds can be achieved.

It is therefore a further object of the present invention to provide a cutter for lengths of zipper material in the manufacturing process of a reclosable package, wherein the length of zipper material can be cut while continuously moving, without the need for intermittent stopping of the zipper length during the cutting process.

These and other objects are attained by providing an apparatus with two stationary or fixed opposed blades with a gap therebetween, the zipper material passing though the gap. The apparatus further includes a reciprocating two-edge blade which can cut on both the down-stroke and the up-stroke.

### BRIEF DESCRIPTION OF THE DRAWINGS

Further objects and advantages of the invention will become apparent from the following description and from the accompanying drawings and claims, wherein:

FIG. 1 is a side plan view of the apparatus of the present invention, shown with the reciprocating blade in the upper position.

FIG. 2 is a side plan view of the apparatus of the present invention, shown with the reciprocating blade in the lower position.

FIG. 3 is a front plan view of the apparatus of the present invention, shown with the reciprocating blade in the lower position, and the length of zipper material in phantom.

### DETAILED DESCRIPTION OF THE PREFERRED EMBODIMENT

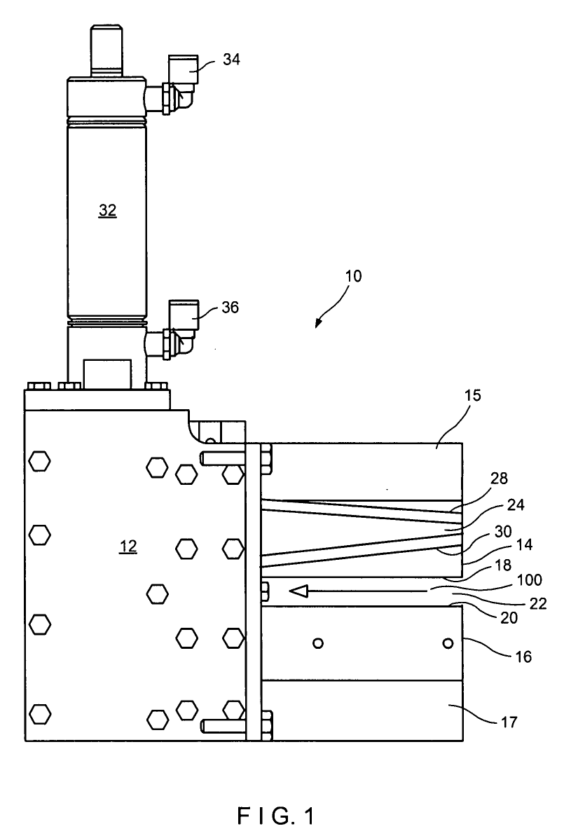

Referring now to the drawings in detail, wherein like numerals refer to like elements throughout the several views, one sees that FIGS. 1-3 are plan views of the cutting apparatus 10 of the present invention.

Casing 12 is provided from which upper and lower blade supports 15, 17 extend. Upper and lower blade supports 15, 17 are typically integral with, or firmly affixed to, casing 12. Upper and lower opposed stationary blades 14, 16 are replaceably engaged by, and seated in, respective upper and lower blade supports 15, 17. Upper opposed stationary blade 14 includes downwardly directed cutting edge 18 while lower opposed stationary blade 16 includes upwardly directed cutting edge 20. Upper opposed stationary blade 14 is immediately over lower opposed stationary blade 16 in an opposed coplanar relationship. Gap 22 is formed between upper and lower opposed stationary blades 14, 16 through which the moving length of zipper material 100 passes, typically continuously moving in the machine direction. Length of zipper material 100 may have nothing attached to it or, in some applications, may have other portions of the reclosable package (not shown) attached. Cutting apparatus 10 is well-adapted, in some applications, for separating the completed reclosable packages from each other, particularly when the length of zipper material 100 provides the connection between subsequent reclosable packages in the manufacturing process, and when the series of completed packages is continuously moving.

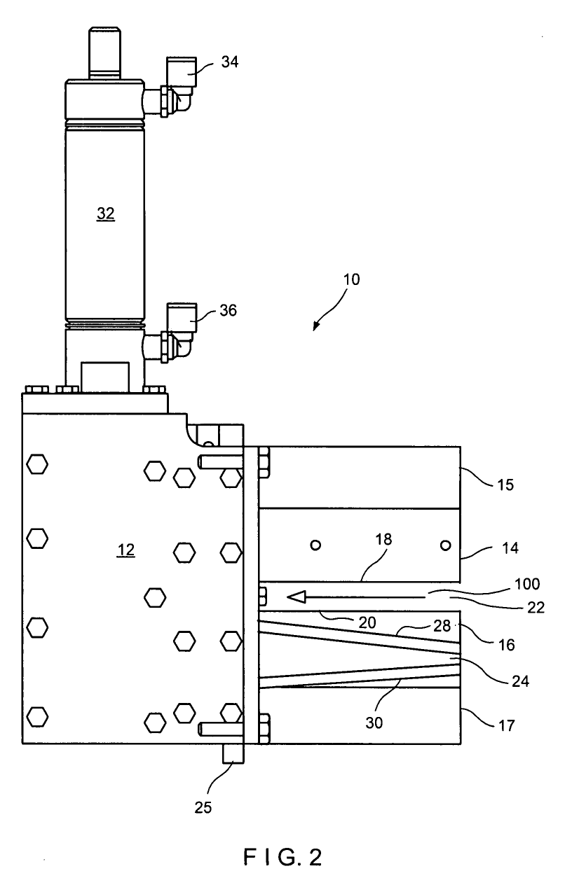

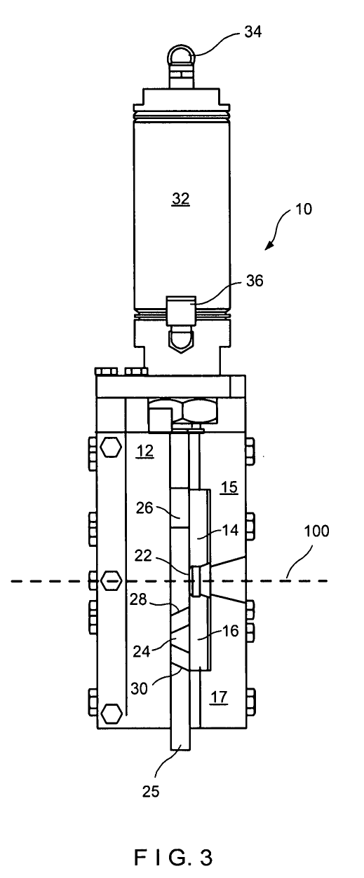

Reciprocating blade 24 reciprocates within slot 26 which is formed immediately adjacent and parallel to upper and lower stationary opposed blades 14, 16 and upper and lower blade supports 15, 17. Reciprocating blade 24 includes linear guide 25 which is slidably captured within slot 26 and which can be seen protruding from the bottom of cutting apparatus 10 in FIGS. 2 and 3. Reciprocating blade 24 includes upper cutting edge 28 and lower cutting edge 30, both of which are oblique to upper and lower stationary opposed blades 14, 16.

Blades 14, 16 and 24 are typically made from metal, such as tool steel or stainless steel selected for its ability to maintain a sharp edge. Additionally, upper and lower blade supports 15, 17 may include internal springs (not shown) to urge upper and lower opposed stationary blades 14, 16 horizontally in order to minimize any horizontal gap between the upper and lower opposed horizontal blades 14, 16 and the reciprocating blade 24.

Two-way gas-driven cylinder 32 is affixed to the top of casing 12. Two-way gas-driven cylinder 32 includes an internal piston (not shown) to which reciprocating blade 24 is affixed or otherwise mechanically responsive. Two-way gas-driven cylinder 32 includes an upper gas inlet 34 and a lower gas inlet 36. By injecting high-pressure gas into upper gas inlet 34, the internal piston is driven downwardly thereby driving the reciprocating blade 24 to the lower position (see FIG. 2). This downward motion of the reciprocating blade 24 severs the length of zipper material 100 between the lower cutting edge 30 of reciprocating blade 24 and the upwardly directed cutting edge 20 of lower opposed stationary blade 16. Likewise, by injecting high-pressure gas into lower gas inlet 36, the internal piston is driven upwardly thereby driving the reciprocating blade to the upper position (see FIG. 1). This upward motion of the reciprocating blade 24 severs the length of zipper material 100 between the upper cutting edge 28 of the reciprocating blade 24 and the downwardly directing cutting edge 18 of upper opposed stationary blade 14. Upper and lower gas inlets 34, 36 have quick exhaust characteristics in order to increase the speed and accuracy of the reciprocation.

Other equivalent methods of inducing the reciprocating motion of blade 24 will be apparent to those skilled in the art after review of the present disclosure.

In this manner, by timing (or by synchronizing with the distance traveled by length of zipper material 100 or other similar methods) the alternation of high pressure gas injected into upper and lower gas inlets 34, 36, a reciprocating motion of reciprocating blade 24 can be achieved, thereby cutting the moving length of zipper material on both the upward and downward strokes.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A cutting device for cutting a moving workpiece in a manufacturing process, comprising:
first and second opposed stationary blades;
a reciprocating blade adjacent to the first and second opposed stationary blades; and
a reciprocating device for reciprocating the reciprocating blade.

2. The cutting device of claim 1 wherein the reciprocating blade includes a first cutting edge and a second cutting edge.

3. The cutting device of claim 2 wherein the first cutting edge is on an upper edge of the reciprocating blade and the second cutting edge is on a lower edge of the reciprocating blade.

4. The cutting device of claim 3 wherein the reciprocating blade reciprocates between a first position and a second position, wherein the lower edge of the reciprocating blade and the second opposed stationary blade perform a cutting action therebetween as the reciprocating blade moves from the first position to the second position, and wherein the upper edge of the reciprocating blade and the first opposed stationary blade perform a cutting action therebetween as the reciprocating blade moves from the second position to the first position.

5. The cutting device of claim 4 wherein the first position is adjacent to the first opposed stationary blade and the second position is adjacent to the second opposed stationary blade.

6. The cutting device of claim 5 further including a gap between the first and second opposed stationary blades.

7. The cutting device of claim 6 wherein material to cut is passed though the gap during reciprocation of the reciprocating blade.

8. The cutting device of claim 7 wherein the reciprocating blade reciprocates within a slot.

9. The cutting device of claim 8 wherein the reciprocating device includes a two-way gas driven cylinder with first and second gas inlets, wherein gas is injected into the first gas inlet to move the reciprocating blade from the first position to the second position and wherein gas is inserted into the second gas inlet to move the reciprocating blade from the second position to the first position.

10. The cutting device of claim 9 wherein the first and second stationary blades are engaged by or seated within respective first and second blade supports.

11. A cutting device for cutting a moving zipper in a process of manufacturing reclosable packages, comprising:
upper and lower opposed stationary blades;
a reciprocating blade adjacent to the upper and lower opposed stationary blades; and
means for reciprocating the reciprocating blade.

12. The cutting device of claim 11 wherein the reciprocating blade includes an upper cutting edge and a lower cutting edge.

13. The cutting device of claim 12 wherein the upper cutting edge and the lower cutting edge are obliquely oriented with respect to the upper and lower opposed stationary blades.

14. The cutting device of claim 13 wherein the reciprocating blade reciprocates between an upper position and a lower position, wherein the lower edge of the reciprocating blade and the lower opposed stationary blade perform a cutting action therebetween as the reciprocating blade moves from the upper position to the lower position, and wherein the upper edge of the reciprocating blade and the upper opposed stationary blade perform a cutting action therebetween as the reciprocating blade moves from the lower position to the upper position.

15. The cutting device of claim 14 wherein the upper position is adjacent to the upper opposed stationary blade and the lower position is adjacent to the lower opposed stationary blade.

16. The cutting device of claim 15 further including a gap between the upper and lower opposed stationary blades.

17. The cutting device of claim 6 wherein the moving zipper is passed though the gap during reciprocation of the reciprocating blade.

18. The cutting device of claim 17 wherein the reciprocating blade reciprocates within a slot.

19. The cutting device of claim 18 wherein the means for reciprocating includes a two-way gas driven cylinder with first and second gas inlets, wherein gas is injected into the first gas inlet to move the reciprocating blade from the upper position to the lower position and wherein gas is inserted into the second gas inlet to move the reciprocating blade from the lower position to the upper position.

20. The cutting device of claim 19 wherein the upper and lower stationary blades are engaged by or seated within respective upper and lower blade supports.
